(19) United States
(12) Patent Application Publication
(10) Pub. No.: US 2011/0268890 A1
(43) Pub. Date: Nov. 3, 2011

(54) METHOD AND DEVICE FOR INDUCTIVELY HEATING A COMPONENT

(75) Inventors: Alexander Gindorf, Schwabhausen (DE); Herbert Hanrieder, Hohenkammer (DE)

(73) Assignee: MTU Aero Engines GMBH, Muenchen (DE)

(21) Appl. No.: 13/138,125

(22) PCT Filed: Apr. 21, 2010
(86) PCT No.: PCT/DE2010/000450

§ 371 Date: Jul. 11, 2011

(30) Foreign Application Priority Data
Apr. 23, 2009 (DE) 10 2009 018 684.0

(51) Int. Cl. H05B 6/36; H05B 6/02; B23K 13/01

(52) U.S. Cl. 427/543; 219/615; 219/672

(57) ABSTRACT

A device (20) for inductively heating at least one region (12, 14) of a component (10) includes a coil device (30) for generating a magnetic field in at least the region (12, 14) of the component (10) and includes an auxiliary member (40) to be configured adjacently to the component (10) in the magnetic field of the coil device (30) in such a way that the auxiliary member (40) faces the component (10) in a direction that is orthogonal or substantially orthogonal to the direction of a magnetic field that the coil device (30) can generate in the region between the component (10) and the auxiliary member (40).

The present invention relates to devices and methods for inductively heating a component and, in particular, to devices and methods for coating a surface of a component or for producing a closing head on a rivet.

### BACKGROUND

Many processes used for processing components entail inductively heating a component or a region of a component. One example is the coating of blade tips of turbine blades for axial compressors or turbines for gas turbine engines for airplanes or other mobile or stationary applications. This process of producing such coatings is also referred to as tip coating. An example is CBN tip coating (CBN=cubic boron nitride). Methods which involve using brazing techniques to apply coatings, whereby the component to be coated and/or the coating are/is inductively coated, are also referred to as induction brazing methods.

For the most part, two essential requirements must be met during induction brazing in the mentioned blade tip coating example. To keep the thermal load on the blades to a minimum, it is important that the heat only be introduced to the blade tip as locally as possible. To obtain a flawless and reproducible product, a most uniform possible temperature distribution over the surface to be brazed, respectively coated is desired. In induction brazing methods used in known methods heretofore for coating blade tips, a pronounced correlation is observed between the generated temperature distribution and the distance between the blade tip and the induction coil. The inhomogeneous temperature distribution that results when working with the normally complex geometries of blades degrades the process result and leads to a high reject rate. In particular, an excessive heating is observed at the front and rear blade edges.

The German Patent Application DE 100 38 158 A1 describes a method for joining articles using plastically deformable joining elements. A radiant heating surrounds the joining element at a close distance. A forming die 11 shapes the joining element in a plasticized state into a rivet head.

The German Patent Application DE 39 09 733 A1 describes methods and devices for repairing or producing a bladed disk. An induction heating coil device is placed around the join region that is provided.

The German Patent Application DE 196 30 488 A1 describes joining methods based on reshaping processes. To effect a contactless heating of the parts being joined, induction loops are provided around a stamp-side and a die-side tool.

The post-published German Patent Application DE 10 2007 054 782 A1 describes devices for inductively heating joining surfaces of metallic components using an induction coil.

U.S. Pat. No. 4,197,441 A1 describes configurations used in a high-frequency induction welding. In all of the specific embodiments described in the text and illustrated in the figures, two surfaces to be joined to one another are mutually opposite.

### SUMMARY OF THE INVENTION

It is an object of the present invention to provide a device and a method for inductively heating, in particular for coating a surface of a component, and for producing a closing head on a rivet.

The present invention provides a device for inductively heating at least one region of a component encompasses a coil device for generating a magnetic field in at least the region of the component. In addition, the device encompasses an auxiliary member, which is designed not to be joined to component (10), but to be configured adjacently to the component in the magnetic field of the coil device, so that it faces the component in a direction that is orthogonal or substantially orthogonal to the direction of a magnetic field that the coil device may generate in the region between the component and the auxiliary member. The coil device may encompass one or a plurality of coil sections that may be configured on both sides of the component and of the auxiliary member, for example. What is meant by opposite direction is, in particular, a direction from a location to be heated, respectively to be processed, or from a center point of a surface to be heated, respectively to be processed, to a location on the auxiliary member located opposite the same or most proximate to this location or center point. The opposite direction and the magnetic field direction are substantially orthogonal when the angle between the two directions is at least 45°, or at least 60°, preferably at least 70°, and more preferably at least 80°.

The auxiliary member may contain a diamagnetic or also a paramagnetic or ferromagnetic material that may be electrically insulating or feature a defined or undefined electrical conductivity. The magnetic properties of the auxiliary member, as well as its electrical conductivity may be adapted to the component, the component region to be heated, and to the material of the component, in particular the magnetic and electrical properties of the material, in the region to be heated. This adaptation may be carried out on the basis of tests, respectively a series of tests, or by numerical simulation. The result of the adaptation may, in particular, be a defined location dependency of the electrical conductivity and of the magnetic properties of the auxiliary member.

The auxiliary member may have a first surface section whose shape is adapted to that of a second surface section of the component. The auxiliary member design may then allow a configuration whereby the first surface section of the auxiliary member is located opposite the second surface section of the component. The shape of the first surface section of the auxiliary member may be adapted to the shape of the second surface section of the component, in particular, in such a way that a defined gap remains between the auxiliary member and the component due to the relative configuration thereof. The width of the gap is constant, for example, or features a defined location dependency.

A holding device for retaining the coil device, the component and the auxiliary member may be provided in order to achieve a defined relative configuration of the coil device, the component and the auxiliary member, the holding device being designed in such a way that the auxiliary member faces the component in a direction that is orthogonal or substantially orthogonal to the direction of the magnetic field that the coil device may generate in the region between the component and the auxiliary member.

The coil device may have a first coil section and a second coil section and may feature an intermediate space between the first coil section and the second coil section for placement of the component and/or the auxiliary member. When a magnetic field generated by the first coil section in a middle region of the first coil section features a first direction, and a magnetic field generated by the second coil section features a second direction in a middle region of the second coil section, the first coil section and the second coil section may be configured in such a way that the first direction and the second direction are the same or substantially the same. Both directions are substantially the same when the angle between the directions is at most 45°, or at most 30°, preferably at most 20° and more preferably at most 10°.

The devices described above may be designed, in particular, for coating a surface of a component by high-temperature induction brazing.

In a method for inductively heating at least one region of a component, at least the region of the component is located near a coil device. An auxiliary member is configured adjacently to the component in such a way that it faces the component in a direction that is orthogonal or substantially orthogonal to the direction of a magnetic field that the coil device may generate in the region between the component and the auxiliary member. The coil device generates a magnetic alternating field that induces an eddy current field at least in the component region to be heated. The auxiliary member is not joined to the component.

In a method for coating a surface of a component, a coating material is first applied to the component surface to be coated. Subsequently thereto, at least either the surface to be coated or the coating material is heated using the above described inductive heating methods.

In all of the above described devices and methods, the component to be heated, respectively the component, whose surface is to be coated, may be a blade for a stator or rotor disk of an axial compressor or of a gas turbine. In this case, the surface to be coated may be an end face of the blade that is configured at the outer periphery of the rotor disk, respectively at the inner periphery of the stator disk.

The method described above for inductively heating at least one region of a component may be used for producing a closing head on a rivet. In this context, a region of the rivet that is to be reshaped into the closing head is inductively heated in accordance with one of the methods described above. The heated region of the rivet is then reshaped into the closing head.

In the above described methods for inductively heating, coating, respectively for producing a closing head, one of the above described devices may be used, in particular. The devices described above may be designed for carrying out one of the above described methods.

The action of the auxiliary member may be based, in particular, on the proximity effect. When the auxiliary member contains an electrically conductive material, a change in the magnetic field generated by the coil device induces an eddy current field in the auxiliary member. The eddy current field generates a magnetic field counter to the change in the magnetic field. In other words, the eddy current field delays the rate at which the change in the magnetic field penetrates into the auxiliary member. Thus, the auxiliary member may contribute to a concentration of a magnetic alternating field generated by the coil device in a region between the auxiliary member and the component. The magnetic alternating field at the component is thereby strengthened.

### BRIEF DESCRIPTION OF THE DRAWINGS

In the following, specific embodiments are explained in greater detail with reference to the accompanying figures, which show:

FIG. 1 a schematic representation of a device in a view from a first direction;

FIG. 2 a schematic representation of the device in a view from a second direction; and

FIG. 3 a schematic flow chart.

### DETAILED DESCRIPTION

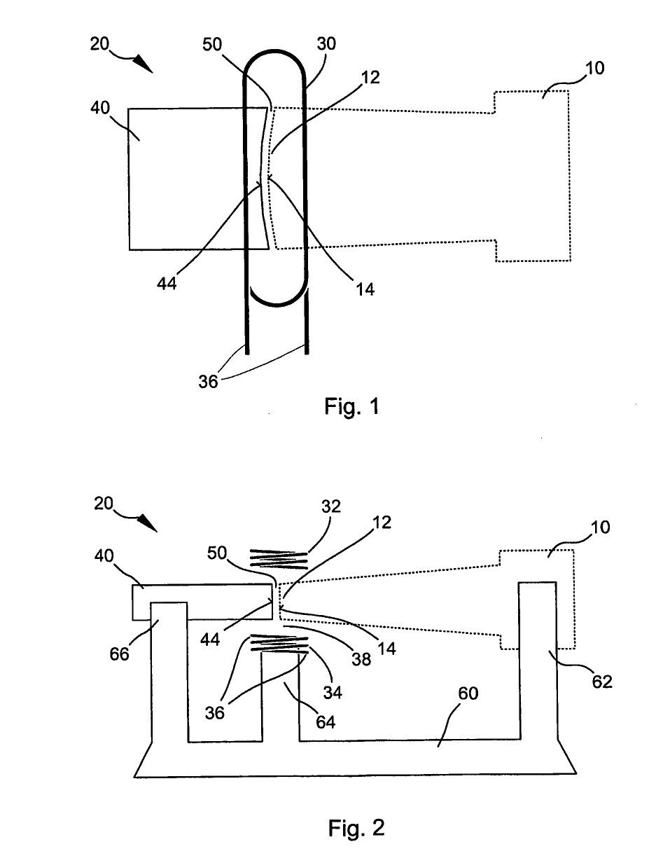

FIGS. 1 and 2 show schematic representations of a component 10 and of a device 20 for inductively heating at least one region of component 10 in views from two different directions. To provide a clear representation, all features are not shown in both FIGS. 1 and 2 since many features are only clearly discernible in one of the two views. To clarify that component 10 is not part of device 20, a component 10 is illustrated by a dotted line.

Component 10 includes a region 12 to be heated. In this example, region 12 to be heated is a thin layer underneath a surface section 14 to be coated. Many applications merely require heating surface section 14. However, it is at least a very thin layer underneath surface section 14 that is actually heated.

When component 10 is a blade for a stator disk or rotor disk of an axial compressor or of a turbine, entire component 10 and, in particular, surface section 14 to be coated of component 10 may have a complex geometry. This is indicated here by a slight curvature of surface section 14.

Device 20 for inductively heating at least region 12, in particular surface section 14 of component 10, includes a coil device 30 and an auxiliary member 40. Coil device 30 includes a first coil section 32 and a second coil section 34. Coil device 30, in particular coil sections 32, 34, include electrical connections 36 which, in FIG. 2, are only provided with a reference numeral for coil section 34. Coil sections 32, 34 may be supplied via electrical connections 36 with electric power, in particular with an alternating current. Coil sections 32, 34 are configured in such a way that an intermediate space 38 is located therebetween.

The direction of the view shown in FIG. 1 is orthogonal or substantially orthogonal to a plane to which the windings of coil sections 32, 34 are parallel or substantially parallel. In the representation in FIG. 1, the two coil sections 32, 34 are directly superposed and, therefore, cannot be distinguished.

The direction of the magnetic field that is generated by one of two coil sections 32, 34 is orthogonal to the drawing plane of FIG. 1 in a middle region of the particular coil section 32, 34. In the representation in FIG. 2, the plane, to which the windings of coil sections 32, 34 are parallel, is orthogonal to the drawing plane; and the magnetic field that is generated by one of two coil sections 32, 34 in the middle region of the particular coil section 32, 34 is parallel to the drawing plane.

An auxiliary member 40 having a surface section 44 is located opposite component 10. Surface section 44 of auxiliary member 40 is located opposite surface section 14 of component 10. The opposite direction is described, in particular, as a direction from a middle region of surface section 14 of component 10 to a middle region of surface section 44 of auxiliary member 40. It is discernible that this opposite direction is at least approximately in the drawing plane in both FIGS. 1 and 2.

A gap 50 having a defined, location-dependent, in particular constant width is disposed between surface section 14 of component 10 and surface section 44 of auxiliary member 40. Region 12 to be heated, in particular surface section 14 of component 10, and gap 50 reside at least approximately in a middle region of intermediate space 38 between coil sections 32, 34. In this configuration and geometry of coil sections 32, 34, as indicated in FIGS. 1 and 2, the direction of the magnetic field generated by entire coil device 30 in gap 50 is orthogonal to the drawing plane in FIG. 1 and parallel to the drawing plane in FIG. 2 and thus orthogonal or substantially orthogonal to the mutual opposite direction of surface section 14 of component 10 and of surface section 44 of auxiliary member 40.

To maintain the described relative configuration of component 10, of coil device 30 and of auxiliary member 40, a holding device 60 is provided with a first support 62 for component 10, a second support 64 for coil device 30 and a third support 66 for auxiliary member 40. For the sake of providing a clear, general representation, a connection of coil section 32 to second support 64 or holding device 60 is not shown.

Auxiliary member 40 may contain a diamagnetic or also a paramagnetic or ferromagnetic material. In addition, the auxiliary member may have a defined, location-dependent or constant electrical conductivity. Auxiliary member 40 is not provided or designed, in particular, for being joined to component 10. The dimensions and the shape of coil sections 32, 34, as well as the relative configuration thereof may deviate from the representations in FIGS. 1 and 2. For example, coil sections 32, 34 may be spaced apart by a distance that corresponds to the width of one coil section. In addition, each of coil sections 32, 34 may have a shape that deviates from a rectangle or an oval and includes two parallel, straight sections. In addition, the windings of coil sections 32, 34 need not extend in parallel to one plane.

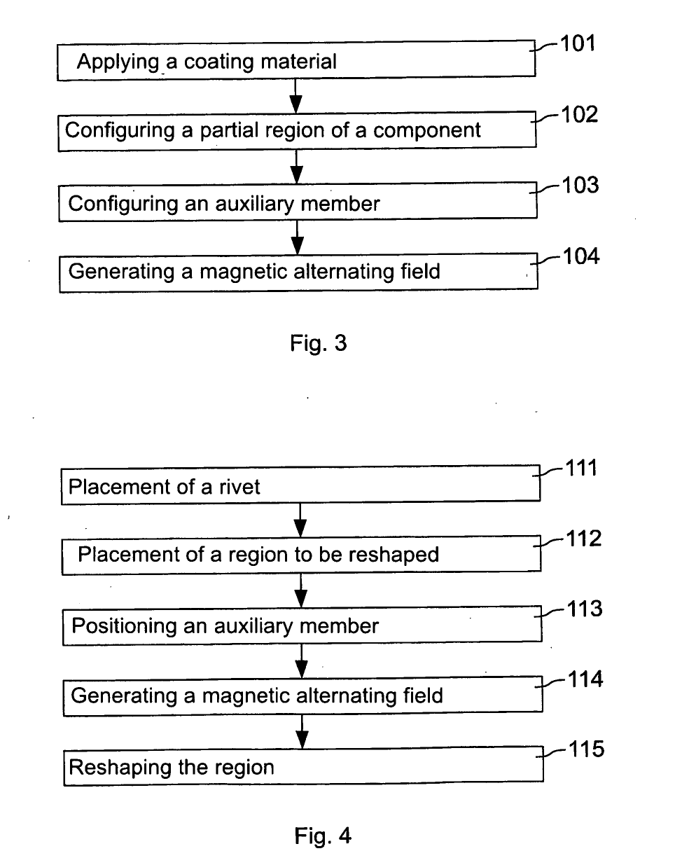

FIGS. 3 and 4 show schematic flow charts of two methods. To facilitate understanding, reference numerals from FIGS. 1 and 2 are used in the following. However, the methods may be implemented both for components that are distinguished from those illustrated above with reference to FIGS. 1 and 2, as well as using devices that are distinguished from those illustrated above with reference to FIGS. 1 and 2.

FIG. 3 shows a schematic flow chart of a method for coating a surface section 14 of a component 10. In a first step 101, a coating material is applied to surface section 14 of component 10 to be coated. In a second step 102, surface section 14 of component 10 to be coated is configured near a coil device 30, in particular in an intermediate space between coil sections 32, 34 of coil device 30. In a third step 103, an auxiliary member 40 is configured adjacently to component 10 in such a way that auxiliary member 40 faces component 10 and, in particular, a surface section 44 of auxiliary member 40 faces surface section 14 of component 10 to be coated, in a direction that is orthogonal or substantially orthogonal to a direction of a magnetic field that may be generated by coil device 30 in the region between component 10 and auxiliary member 30. In a fourth step 104, coil device 30 generates a magnetic alternating field that induces an eddy current field at surface section 14 of component 10 to be coated. Due to the electrical resistance of the material of component 10, eddy current field heats component 10, i.e., at least region 12 in which the eddy current field is produced. Alternatively or additionally, an eddy current field is produced in the coating material that is applied in first step 101, thereby heating the same. In response to the resulting increased temperature at surface 14 of the component and in the coating material, the coating material binds itself to surface 14 of the component. This bond may be produced in a brazing process, in particular a high-temperature brazing process.

FIG. 4 shows a schematic flow chart of a method for producing a closing head on a rivet. In a first step 111, a rivet is placed in a bore in one or two elements to be mechanically connected to one another. In a second step 112, a region of the rivet that is to be reshaped into the closing head is placed next to a coil device. In a third step 113, an auxiliary member is positioned adjacently to the rivet or to the element(s) in such a way that it faces opposite the rivet, respectively the elements in a direction that is orthogonal or substantially orthogonal to the direction of a magnetic field that is generated by coil device 30 in the region between the rivet, respectively the elements and the auxiliary member. In a fourth step 114, coil device 30 generates a magnetic alternating field that induces an eddy current field at least either in the region of the rivet to be heated or in the element(s). In a fifth step 115, the rivet region to be reshaped is reshaped into a closing head.

In both methods illustrated in FIGS. 3 and 4, second step 102, respectively 112, third step 103, respectively 113, and fourth step 104, respectively 114 each constitute a method for inductively heating at least one region of a component, for example a rivet or a blade for an axial compressor or a turbine. This inductive heating method may also be applied within the framework of other processes. In both methods illustrated in FIGS. 3 and 4, the auxiliary member is not joined to the component, in particular. Instead, it may be reused in the course of heating of other components.

1-15. (canceled)

16. A device for inductively heating at least one region of a component, comprising:
a coil device for generating a magnetic field in at least the region of the component;
an auxiliary member, designed not to be joined to the component and for being configured adjacently to the component in the magnetic field of the coil device in such a way that the auxiliary member faces the component in a direction orthogonal or substantially orthogonal to a direction of the magnetic field generatable in the region between the component and the auxiliary member.

17. The device as recited in claim 16 wherein the auxiliary member has a first surface section whose shape is adapted to that of a second surface section of the component, the design of the auxiliary member allowing a configuration where the first surface section of the auxiliary member faces opposite the second surface section of the component.

18. The device as recited in claim 16 further comprising a holding device designed to retain the coil device, the component and the auxiliary member in such a way that the auxiliary member faces the component in the direction orthogonal or substantially orthogonal to the direction of the magnetic field generatable in the region between the component and the auxiliary member.

19. The device as recited in claim 16 wherein the coil device has a first coil section and a second coil section, an intermediate space being provided between the first and second coil sections for placement of the component.

20. The device as recited in claim 19 wherein the first coil section and the second coil section are configured in such a way that the magnetic field generated by the first coil section in a middle region of the first coil section has a first direction, and the magnetic field generated by the second coil section in a middle region of the second coil section has a second direction, the first direction and the second direction being the same or substantially the same.

21. The device as recited in claim 19 wherein the component has a coat on a surface section provided by high-temperature induction brazing of the device.

22. A method for inductively heating at least one region of a component, comprising the following steps:
positioning at least the region of the component adjacent a coil device;
configuring an auxiliary member adjacently to the component in such a way that the auxiliary member faces the component in a direction orthogonal or substantially orthogonal to a direction of a magnetic field that the coil device can generate in a region between the component and the auxiliary member; and
generating a magnetic alternating field by the coil device, the magnetic alternating field inducing an eddy current field at least in the region of the component, the auxiliary member not being joined to the component.

23. The method as recited in claim 22 wherein the auxiliary member has a first surface section whose shape is adapted to that of a second surface section of the component, the auxiliary member being configured in such a way that the first surface section of the auxiliary member faces opposite the second surface section of the component.

24. The method as recited in claim 22 wherein the component and the auxiliary member are each configured at least partially in an intermediate space between a first coil section and a second coil section of the coil device.

25. The method as recited in claim 22 wherein the first coil section and the second coil section are configured in such a way that the magnetic field that the first coil section generates in a middle region of the first coil section has a first direction, and the magnetic field that the second coil section generates in a middle region of the second coil section has a second direction, the first direction and the second direction being the same or substantially the same.

26. A method for coating a surface section of a component, comprising the following steps:
applying a coating material to the surface section of the component to be coated; and
heating at least either the surface section to be coated or the coating material in accordance with claim 22.

27. The method as recited in claim 26 wherein the component is a blade for a stator disk or rotor disk of an axial compressor or of a turbine, and the surface section to be coated is an end face of the blade that is configured at an outer periphery of the rotor disk or, respectively, at the inner periphery of the stator disk.

28. A method for producing a closing head on a rivet, comprising the following steps:
heating a region of a rivet to be reshaped into a closing head in accordance with claim 22; and
reshaping the region of the rivet to be reshaped into a closing head.

29. A method for inductively heating at least one region of a component using the device as recited in claim 16, comprising the following steps:
positioning at least the region of the component adjacent a coil device;
configuring an auxiliary member adjacently to the component in such a way that the auxiliary member faces the component in a direction orthogonal or substantially orthogonal to a direction of a magnetic field that the coil device can generate in a region between the component and the auxiliary member; and
generating a magnetic alternating field by the coil device, the magnetic alternating field inducing an eddy current field at least in the region of the component, the auxiliary member not being joined to the component.

30. A device for inductively heating at least one region of a component in accordance with the method as recited in claim 22, comprising:
a coil device for generating a magnetic field in at least the region of the component;
an auxiliary member, designed not to be joined to the component and for being configured adjacently to the component in the magnetic field of the coil device in such a way that the auxiliary member faces the component in a direction orthogonal or substantially orthogonal to a direction of the magnetic field generatable in the region between the component and the auxiliary member.
